(19) United States
(12) Patent Application Publication
(10) Pub. No.: US 2005/0015050 A1
(43) Pub. Date: Jan. 20, 2005

(54) Apparatus for depositing fluid material onto a substrate

(75) Inventors: Christopher Douglas Mowery, Syracuse, UT (US); Aaron Michael Hagge, Ogden, UT (US); Christopher Aaron Hadley, Ogden, UT (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Kimberly-Clark Worldwide, Inc.

(21) Appl. No.: 10/620,166

(22) Filed: Jul. 15, 2003

(51) Int. Cl. B05C 5/00

(52) U.S. Cl. 604/131

(57) ABSTRACT

Apparatus for depositing fluid material onto a moving substrate includes at least two nozzle units substantially aligned along a direction of alignment. The nozzle units are mounted on a transfer plate secured to a manifold used to deliver fluid material to the nozzle units. The transfer plate is mounted on the manifold by a mounting system which allows adjustment of the transfer plate position (and nozzle units thereon) relative to the manifold in the direction of alignment. Supply ports in the manifold remain in fluid communication with a number of stacked supply channels in the transfer plate during such adjustment. In another embodiment, recirculation units are attached to the transfer plate. The transfer plate has an inflow recirculation passage providing fluid communication between the manifold supply ports and the recirculation units and an outflow recirculation passage providing fluid communication between the recirculation units and return ports of the manifold.

### BACKGROUND OF THE INVENTION

The present invention relates to apparatus for depositing fluid material on a moving web, and more particularly to such apparatus for accurately spraying a predetermined volumetric flow of adhesive in a selected pattern on a continuously moving web.

Absorbent articles, such as disposable diapers, training pants, adult incontinence articles and the like, generally include several different components which are adhesively bonded together. For example, adhesive has been used to bond together individual layers of an absorbent diaper, such as the outer cover and bodyside liner. Adhesive has also been used to bond discrete pieces to an article, such as fasteners and leg elastics. Typically, the adhesive has been sprayed or slot-coated on a continuously-moving web used to make the absorbent article. The sufficiency of the adhesive bond between the components of the article is generally dependent on the type of materials, the amount of adhesive, the type of adhesive, and the spray pattern of the adhesive.

Various techniques have been used for spraying adhesive on a moving substrate are well know to those skilled in the art. By way of example, adhesive has been applied by applicators of the type shown in U.S. Pat. No. 4,949,668 to Heindel et al., titled Apparatus for Sprayed Adhesive Diaper Construction, issued Aug. 21, 1990; U.S. Pat. No. 4,995,333 to Keller et al., titled Sprayed Adhesive System for Applying a Continuous Filament of Thermoplatic Material and Imparting Swirling Motion Thereto, issued Feb. 26, 1991; and U.S. Pat. No. 5,618,347 to Clare et al., titled Apparatus for Spraying Adhesive, issued Apr. 8, 1997; all assigned to Kimberly-Clark Corporation and all incorporated by reference herein. In general, these applicators have banks of nozzles aligned generally transversely relative to the direction of machine feed (i.e., the nozzles are aligned in a cross-machine direction). The positions of the nozzles are adjustable in the cross-machine direction to accommodate different grades (types or sizes) of product, such as diapers of different width. In conventional designs, this range of adjustment is typically relatively small.

The number and location of the nozzles used for making a particular product varies, depending on factors such as product width and the pattern of adhesive to be applied. When one or more nozzles are not in use, the flow of adhesive to these nozzles is typically blocked, and the adhesive is diverted along a recirculation path for return to the source of adhesive. While this technique has proven to be generally satisfactory, conventional recirculation paths involve complex passage designs resulting in increased cost and larger space requirements. Further, the recirculation paths have included substantial lengths of dead space where adhesive material stagnates when it is not recirculating. Such material can deteriorate over time (e.g., due to prolonged heating) and block the orifices of the nozzle units which must then be replaced.

### SUMMARY OF THE INVENTION

In general, an apparatus according to one embodiment of the present invention for depositing a pattern of fluid material onto a substrate moving in a machine direction comprises at least first and second nozzle units substantially aligned in a direction of alignment. A delivery system delivers the material to the nozzle units and comprises a manifold having first and second supply ports located one above the other for supply of material to the nozzle units. A transfer plate of the delivery system is disposed between the manifold and the nozzle units, with the nozzle units being secured to the transfer plate. Supply passaging in the transfer plate delivers fluid material from the manifold supply ports to the nozzle units and comprises a first elongate supply channel in a first face of the transfer plate in fluid communication with the first supply port in the manifold, and a second elongate supply channel in the first face of the transfer plate in fluid communication with the second supply port in the manifold. The first and second supply channels extend in the direction of alignment and are located one above the other in stacked relation. A mounting system mounts the transfer plate on the manifold and allows adjustment of the position of the transfer plate and nozzle units thereon relative to the manifold in the direction of alignment. The manifold supply ports remain in fluid communication with respective supply channels during said adjustment.

In another embodiment, apparatus for depositing a pattern of fluid material onto a substrate moving in a machine direction generally comprises a nozzle unit having an inlet port for receiving the material and a nozzle for depositing the material on the substrate. A recirculation unit has an inlet port for receiving the material and an outlet port. A delivery system delivers material to the nozzle unit and comprises a control system for selectively directing the material either to the nozzle unit for dispensing on the substrate or to the recirculation unit for recirculation. A manifold has a supply port for supply of material to the inlet port of the nozzle unit, and a return port for receiving material from the recirculation unit. The delivery system further comprises a transfer plate having a first face facing the manifold, and first supply passaging in the transfer plate providing fluid communication between said manifold supply port and the inlet port of the nozzle unit. The supply passaging comprises an elongate channel in the first face of the transfer plate. The transfer plate also has first recirculation passaging comprising a first inflow recirculation passage providing fluid communication between the manifold supply port and the inlet port of the recirculation unit, and a first outflow recirculation passage providing fluid communication between the outlet port of the recirculation unit and the return port of the manifold. The outflow recirculation passage comprises an elongate return channel in the first face of the transfer plate in a generally stacked relation with the supply channel. The nozzle unit and recirculation unit are attached to the transfer plate with the inlet port of the nozzle unit in fluid communication with the supply passaging in the transfer plate, with the inlet port of the recirculation unit in fluid communication with the inflow recirculation passage in the transfer plate, and with the outlet port of the recirculation unit in fluid communication with the outflow recirculation passage in the transfer plate. The transfer plate is mounted on the manifold with the supply channel in the transfer plate in fluid communication with the manifold supply port and with the return channel in the transfer plate in fluid communication with the manifold return port.

In yet another embodiment, apparatus for depositing a pattern of fluid material onto a substrate moving in a machine direction generally comprises at least a first nozzle unit having an inlet port for receiving the material and a nozzle for depositing the material on the substrate. At least a first recirculation unit has an inlet port for receiving the material and an outlet port. The apparatus further comprises a delivery system comprising a control system for selectively directing the material either to the nozzle unit for dispensing on the substrate or to the recirculation unit for recirculation. A manifold of the delivery system has a first supply port for supply of material to the inlet port of the nozzle unit, and a return port for receiving material from the recirculation unit. A transfer plate is secured to the manifold and has a first face facing the manifold. The transfer plate has first supply passaging therein providing fluid communication between the manifold supply port and the inlet port of the nozzle unit, and first recirculation passaging therein comprising a first inflow recirculation passage providing fluid communication between the manifold supply port and the inlet port of the recirculation unit, and a first outflow recirculation passage providing fluid communication between the outlet port of the recirculation unit and the return port of the manifold. The nozzle unit and recirculation unit are attached to the transfer plate with the inlet port of the nozzle unit in fluid communication with the supply passaging in the transfer plate, with the inlet port of the recirculation unit in fluid communication with the inflow recirculation passage in the transfer plate, and with the outlet port of the recirculation unit in fluid communication with the outflow recirculation passage in the transfer plate.

### BRIEF DESCRIPTION OF THE DRAWINGS

FIG. 1 is a perspective of a prior applicator for applying adhesive to a continuously moving substrate;

FIG. 2 is a fluid flow schematic of the applicator of FIG. 1;

FIG. 3 is schematic front view of several nozzle units mounted on a manifold of the applicator;

FIG. 4 is a schematic sectional view along lines 4—4 of FIG. 3 showing fluid passaging from the manifold and through the transfer plate to the nozzle units;

FIG. 5 is a perspective of one embodiment of an applicator of the present invention;

FIG. 6 is an exploded perspective of the embodiment of FIG. 5, showing two front nozzle banks exploded away from a manifold of the applicator;

FIG. 7 is an exploded perspective of the embodiment of FIG. 5, showing a rear nozzle bank exploded away from the manifold;

FIG. 8 is a fluid flow schematic of the applicator of FIG. 5;

FIG. 9 is a front view of a transfer plate of the applicator of FIG. 5;

FIG. 10 is a rear view of the transfer plate of FIG. 9;

FIG. 11 is a sectional view along line 11-11, of FIG. 9 showing passaging through the transfer plate in fluid communication with a first recirculation unit attached to the front face of the plate;

FIG. 12 is a sectional view along line 12-12, of FIG. 9 showing passaging through the transfer plate in fluid communication with a first nozzle unit attached to the front face of the plate;

FIG. 13 is a sectional view along line 13-13, of FIG. 9 showing passaging through the transfer plate in fluid communication with a second nozzle unit attached to the front face of the plate;

FIG. 14 is a sectional view along line 14-14, of FIG. 9 showing passaging through the transfer plate in fluid communication with a second recirculation unit attached to the front face of the plate;

FIG. 15 is an enlarged view showing a seal around a channel in the rear face of the transfer plate; and

FIG. 16 is a front view illustrating adjustment of the transfer plate relative to the manifold in a cross-machine direction.

Corresponding parts are designated by corresponding reference numbers throughout the several views of the drawings.

### DETAILED DESCRIPTION OF THE INVENTION

The present invention is directed to a distinctive apparatus for depositing a selected pattern of material onto a selected substrate, such as the outer cover layer of a disposable diaper. While the following description will be made in the context of depositing a hot-melt adhesive, it will be readily apparent to persons of ordinary skill that other types of adhesives and other types of viscous, extrudable materials, such as ointments, etc., may also be applied by employing the technique of the invention. Similarly, while the following description will be made in the context of constructing a disposable diaper, it will be readily apparent that the technique of the present invention would also be suitable for producing other articles, such as training pants, feminine care products, incontinence products, disposable gowns, laminated webs, and the like.

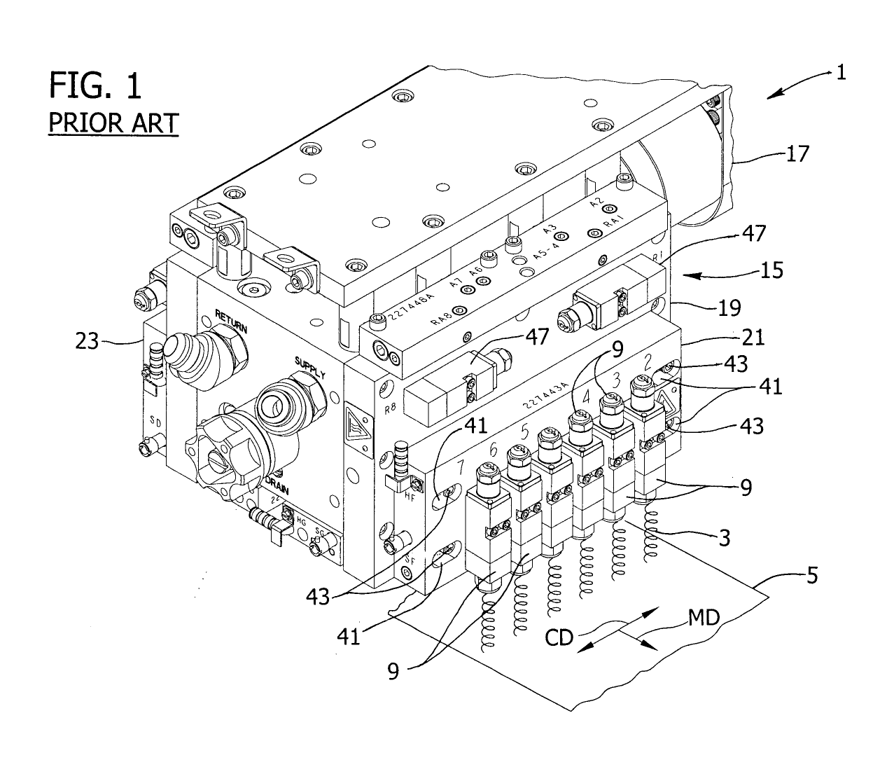

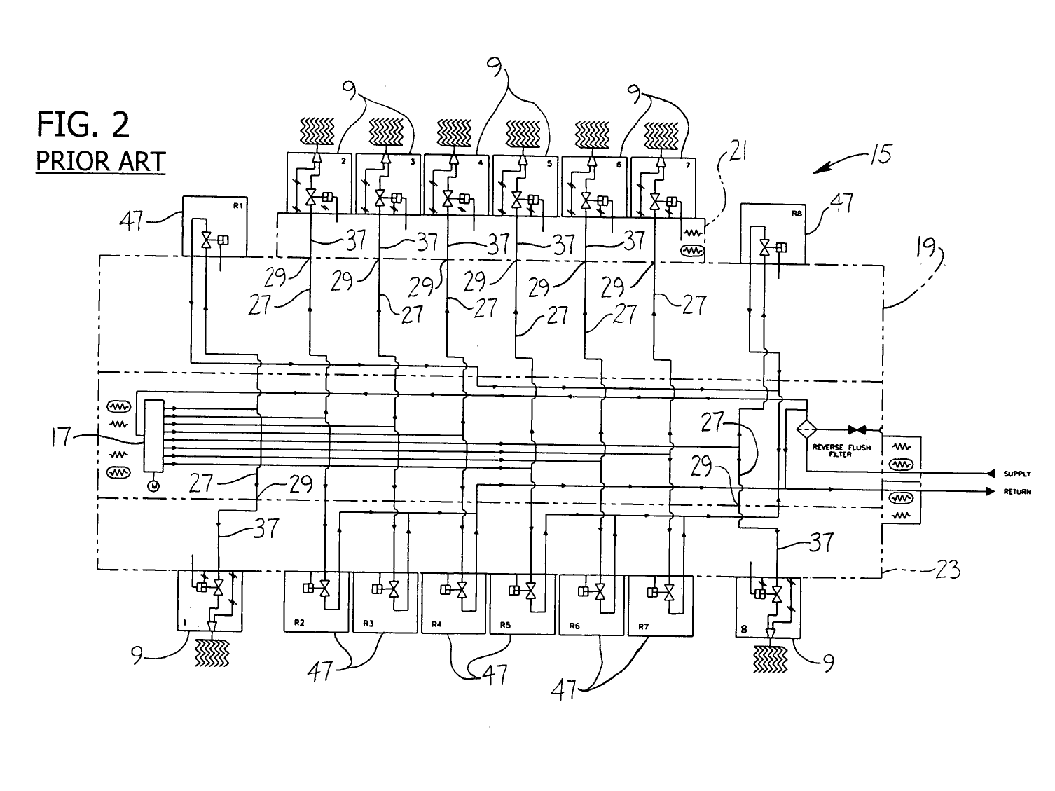

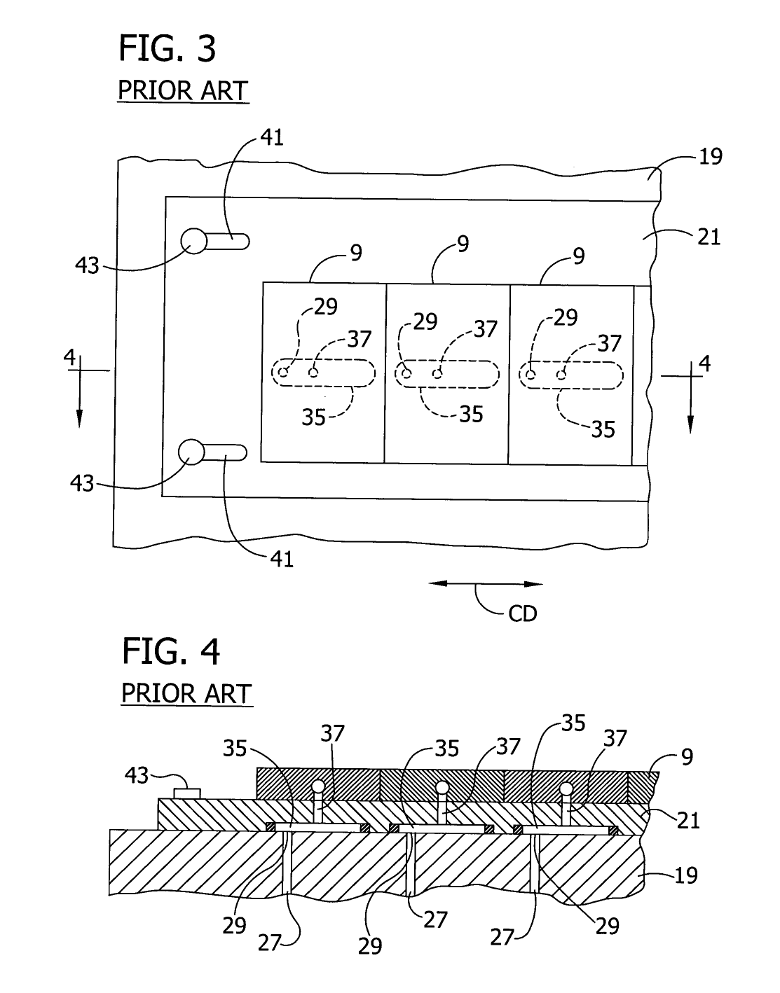

FIGS. 1-4 show an adhesive applicator of conventional design, designated in its entirety by the reference numeral 1, for depositing a pattern of fluid material 3 (e.g., a hot-melt adhesive) onto a substrate 5 moving in a machine direction MD. By way of example but not limitation, the substrate may be a web of material corresponding to the outer cover layer of a diaper. The applicator comprises a plurality of nozzle units 9 substantially aligned along a cross-machine direction CD (broadly, a direction of alignment) extending generally transverse to the machine direction MD, the machine direction being the direction of web movement. A delivery system, generally designated 15, delivers fluid material to the nozzle units 9 from a source of such material (not shown). In general, this system includes a pump and motor unit 17, a heated manifold 19, and front and rear transfer plates 21, 23 mounted on the front and rear faces of the manifold. The particular applicator shown in FIGS. 1 and 2 has eight nozzle units 9, six units mounted side-by-side on the front transfer plate 21 and two mounted side-by-side on the rear transfer plate 23 (see FIG. 2). As illustrated in FIG. 2, which shows a fluid schematic of the system, adhesive is pumped to respective nozzle units 9 via manifold supply passages 27 which terminate at supply ports 29 at one side of the manifold, and passaging in the front transfer plate 21. The passaging in the transfer plate 21 includes a number of channels 35 (FIGS. 3 and 4), one for each nozzle unit 9, machined in the face of the plate facing the manifold, and flow passages 37 connecting the channels 35 to respective nozzle units 9. The channels 35 are aligned in the cross-machine direction CD and are in fluid communication with respective manifold supply ports 29. The transfer plate 21 has one or more mounting slots 41 in it for receiving fasteners 43 which secure the transfer plate to the manifold 19. By loosening the fasteners 43, the transfer plate 21 can be adjusted in the cross-machine direction CD to accommodate product grade changes. The range of adjustment is limited by the lengths of the channels 35 in the transfer plate 21, which must remain in fluid communication with the manifold supply ports 29. In conventional designs, the length of each transfer plate channel 35 is relatively short (less than the width of a respective nozzle unit 9), which restricts the available range of adjustment.

The applicator shown in FIGS. 1 and 2 includes a series of recirculation units 47, one per nozzle unit 9, mounted on the manifold 19. Some of the units 47 (e.g., six units) are mounted on the rear of the manifold 19 and others (e.g., two units) are mounted at the front of the manifold above the front transfer plate 21. As shown in FIG. 2, this arrangement requires a relatively complex design of bores in the manifold 19 and a substantial amount of dead space where adhesive material can stagnate when not recirculating. The complex bore design requires a larger manifold and increased fabrication costs, and the large amount of dead space results in excessive charring (overheating), solidification and thermal degradation of stagnant adhesive when it is not recirculating. This can result in charred particles clogging the adhesive flow passages of the manifold or, more likely, the nozzle units 47.

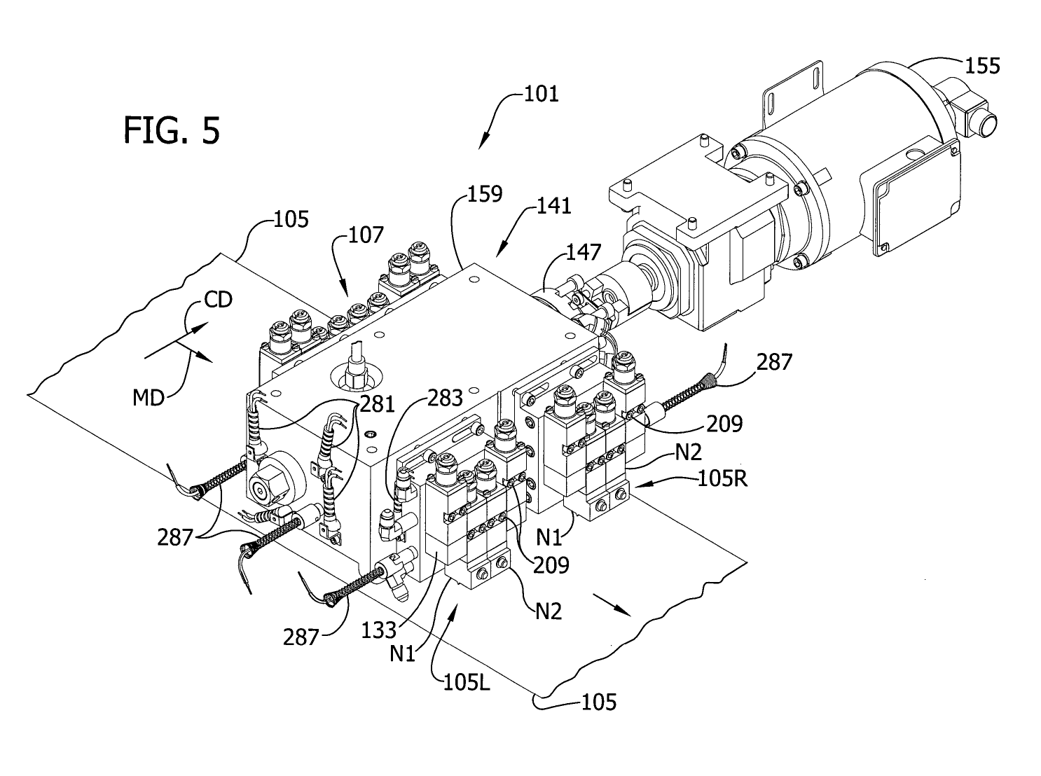

FIGS. 5-7 show one embodiment of an applicator of the present invention, generally designated 101, for depositing a fluid material 103 such as hot-melt adhesive, on a substrate 105 moving in a machine direction MD. By way of example, the substrate may be a continuously moving web used in the fabrication of an absorbent disposable diaper. The illustrated applicator 101 includes a number of nozzle units, each generally designated N. The specific number of nozzle units N may vary from two to eight or more, eight such units being present in the embodiment of FIGS. 5-7. The nozzle units N are arranged in three banks, including left and right front nozzle banks 105L, 105R for depositing (e.g., spraying) adhesive material 103 along respective longitudinal side margins of the web 105, and a rear bank 107 for depositing such material on the central longitudinal region of the web. Each of the two front nozzle banks 105R, 105L has two nozzle units N1, N2, and the rear nozzle bank includes four nozzle units N4-N6, although the number of nozzle banks and the number of nozzle units in each bank may vary.

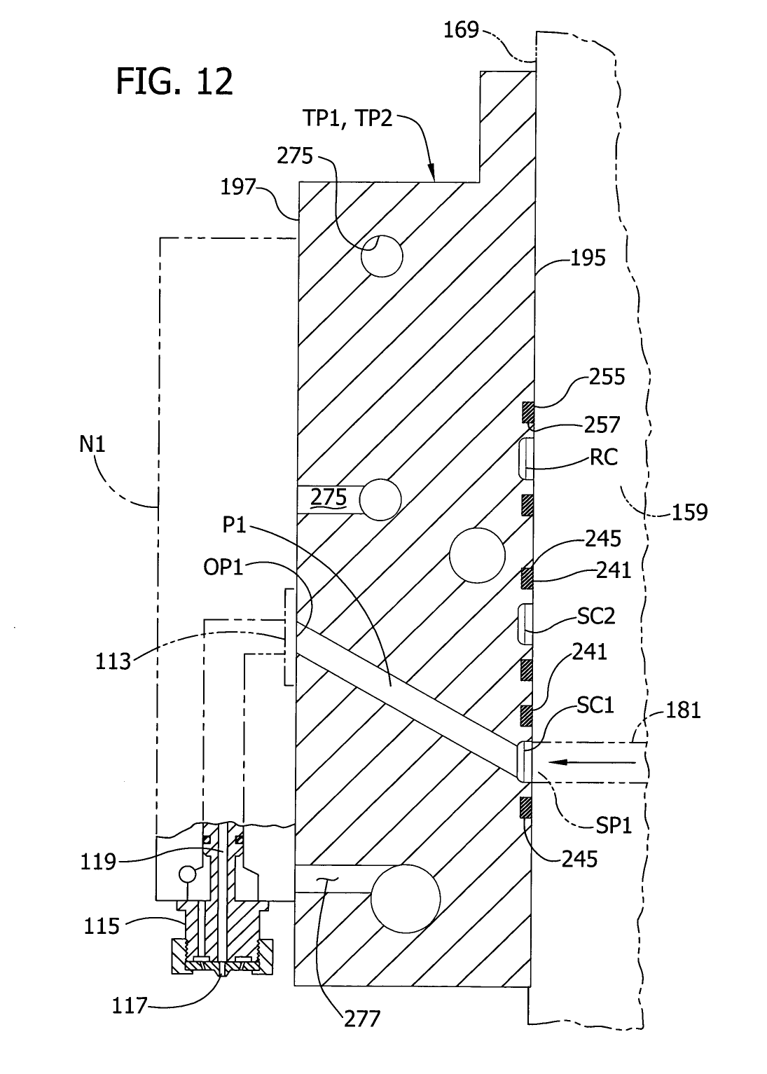

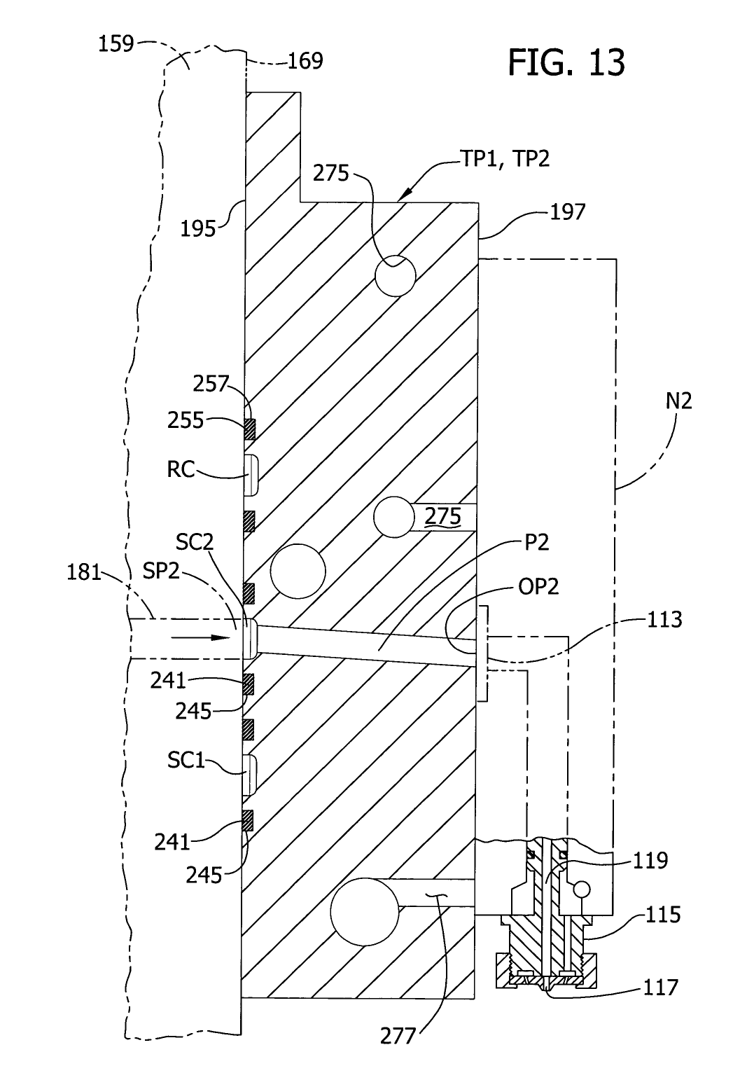

The nozzle units N1, N2 in the front nozzle banks are substantially aligned along a direction of alignment thereof (e.g., in the illustrated embodiment, along a cross-machine direction CD extending generally transverse to the machine direction MD). The nozzle units N1, N2 of each bank are mounted adjacent one another, preferably in close side-by-side relation. As shown best in FIGS. 12 and 13 each nozzle unit N has an inlet port 113 for receiving adhesive or other fluid material, a nozzle 115 defining an orifice 117 through which a stream of material flows for deposit on the substrate, and a nozzle passage 119 connecting the inlet port 113 and the nozzle. In one embodiment (e.g., FIGS. 5-7), each nozzle unit N comprises a stack of modular, generally cubical blocks 121. The construction and operation of the nozzle units N is conventional and thus will not be described in further detail. Suitable nozzle units N are commercially available from Nordson Corporation, a business having offices located in Duluth, Ga., as Model No. MB200 series (P/N 327959) and CF-200 series (P/N 144906). Such nozzles are typically configured to be operated between an “on” position and an “off” position to control the flow of adhesive from the nozzles.

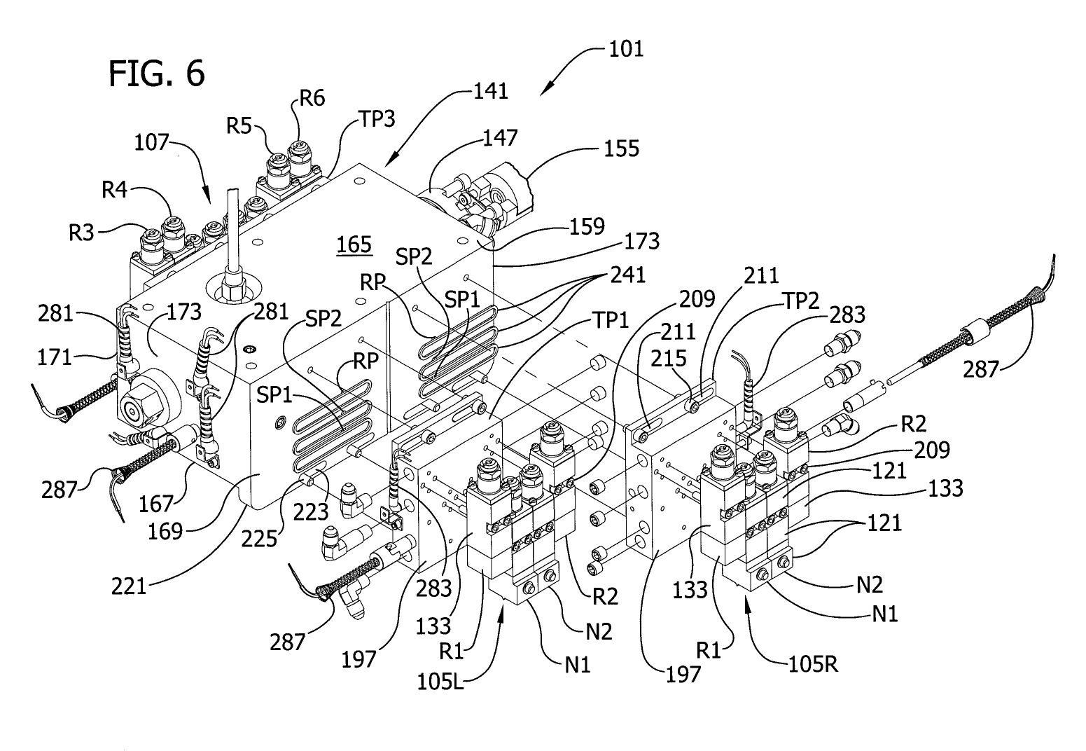

The applicator 101 also includes a number of recirculation units R for recirculating fluid material when one or more nozzle units N are not in use, as will be described hereinafter. The recirculation units R are mounted generally adjacent the nozzle units N. In the embodiment shown in the drawings, one recirculation unit R is provided for each nozzle unit N, and the recirculation units are mounted at opposite sides of each bank of nozzle units. Thus, in the illustrated embodiment (FIGS. 6-8), the two nozzle units N1, N2 of each front bank of nozzle units are disposed between two recirculation units R1, R2, and the four nozzle units N3-N6 of the rear bank of nozzle units are disposed between two pairs of recirculation units R3-R6. Other nozzle and recirculation unit arrangements are also possible.

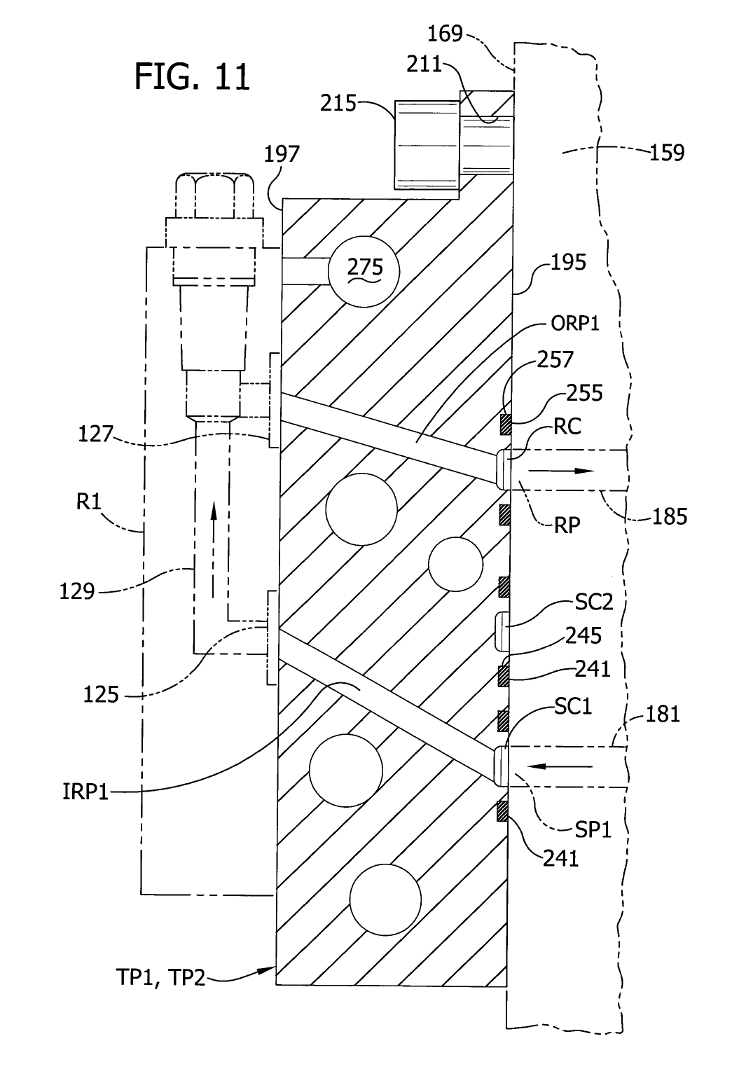

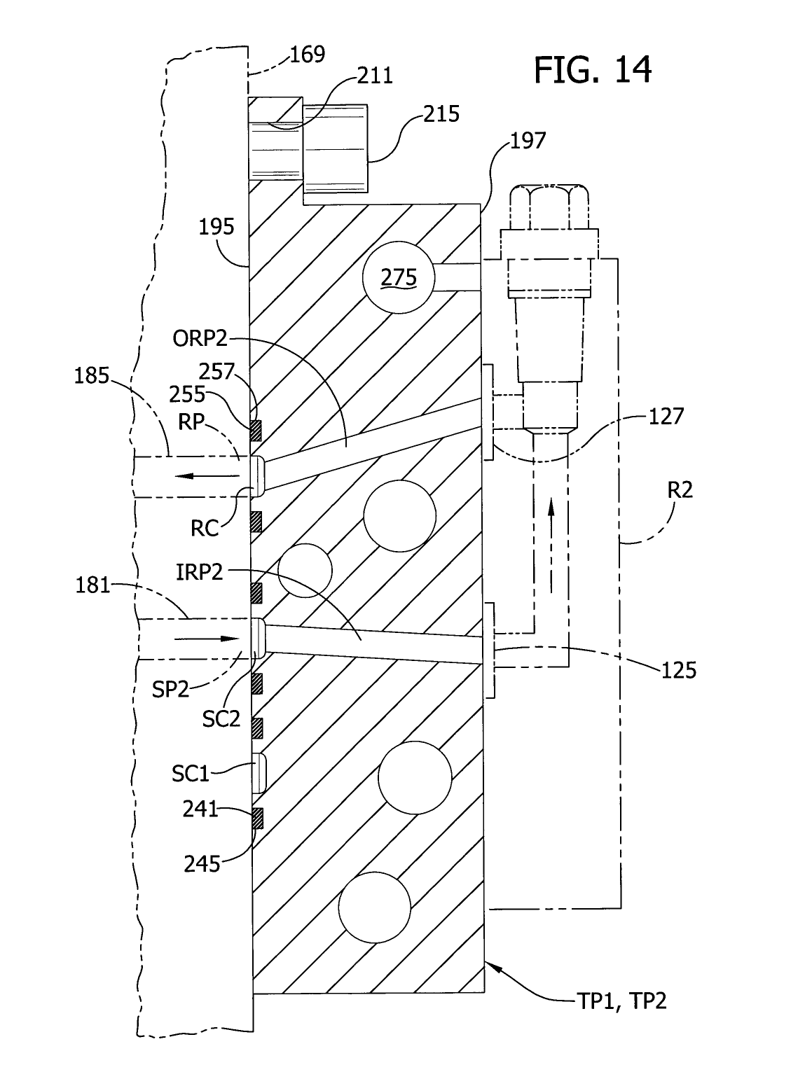

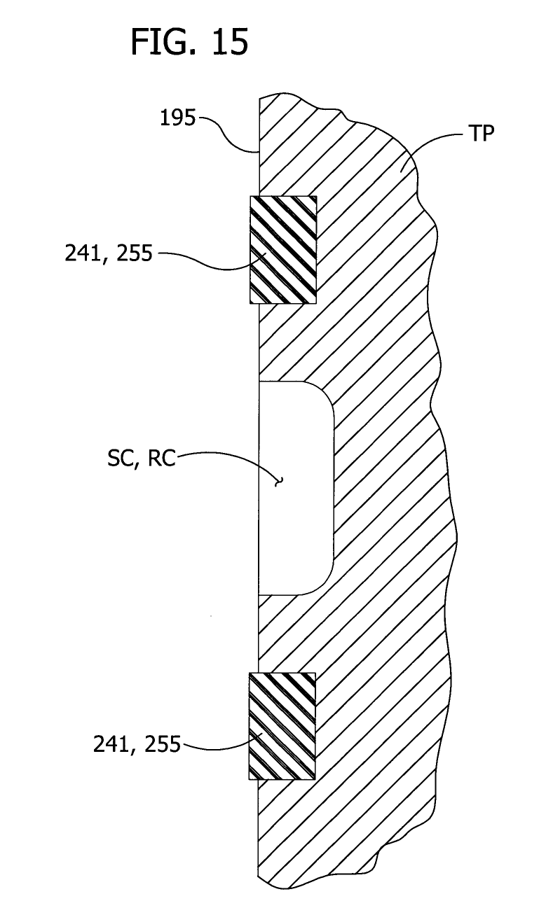

Referring to FIGS. 11 and 14, each recirculation unit R1, R2 has an inlet port 125, an outlet port 127, and a flow passage 129 connecting the inlet and outlet ports. In one embodiment (e.g., FIGS. 5-7), the unit comprises a stack of modular, generally cubical blocks 133, like the modular blocks 121 of the nozzle units N. Suitable recirculation units R are commercially available from the same sources referred to above providing the nozzle units N.

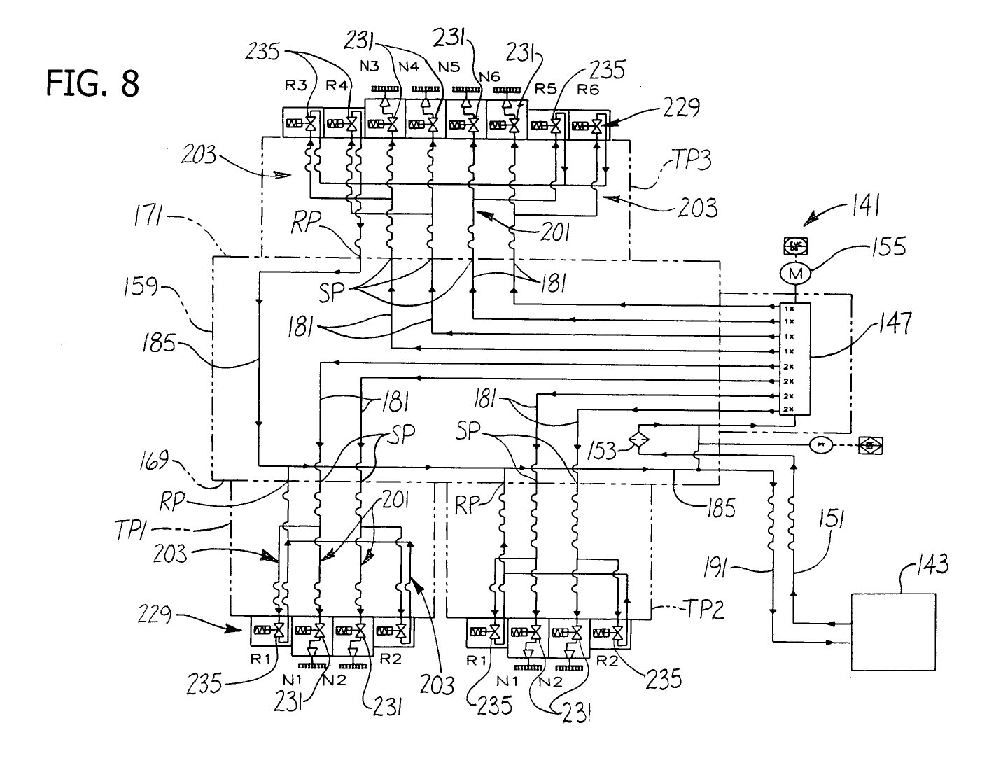

The applicator 101 also includes a delivery system generally indicated at 141, for delivering fluid material 103 to the nozzle units N from a source (e.g., reservoir 143 in FIG. 8) of such material. This system comprises, in one embodiment, a metering pump 147 connected to the source 143 by a flow line 151 having a filter 153 in it (FIG. 8), a motor 155 for driving the pump, a manifold 159, and a plurality of transfer plates TP, one for each nozzle bank 105L, 105R, 107. In this particular embodiment, the manifold 159 comprises a block of suitable material (e.g., metal) having a series of passages therein for the flow of fluid material to the nozzle and recirculation units N, R, and for recirculating the flow of material from the recirculation units R. The manifold 159 has a top face 165, a bottom face 167, a front face 169, a rear face 171, and opposite end faces 173 (FIG. 6). The manifold 159 can be a one-piece monolithic block or it can be fabricated as multiple pieces which are secured together. The left and right front nozzle banks 105L, 105R are located forward of the front face 169 of the manifold and the rear nozzle bank 107 is located rearward of the rear face 171 of the manifold.

Referring to FIG. 8, the passages in the manifold 159 include a number of supply passages 181 connecting the outlets of the pump 147 to respective supply ports SP in the front and rear faces 169, 171 of the manifold, and return passages 185 connecting return ports RP in the front and rear faces 169, 171 of the manifold to a return line 191 at one end of the manifold leading to the source of adhesive. The passages are formed in conventional fashion, as by bores formed by drilling or other suitable means.

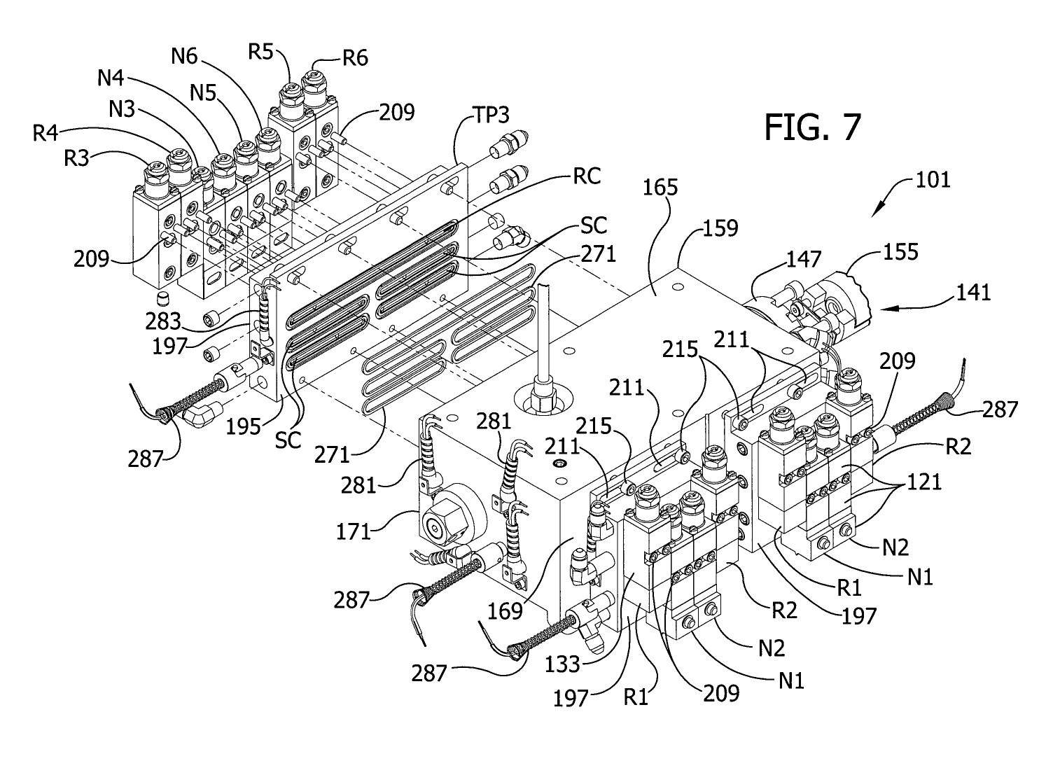

A transfer plate TP1, TP2 is disposed between the front face 169 of the manifold 159 and each of the two front banks 105L, 105R of nozzle units N and associated recirculation units R, the left transfer plate being indicated at TP1 in FIG. 6 and the right transfer plate being indicated at TP2. Similarly, a third transfer plate TP3 (FIG. 7) is disposed between the rear face 171 of the manifold 159 and the rear bank of nozzle units N and associated recirculation units R. Each transfer plate TP has a first face 195 facing the manifold and a second face 197 facing respective nozzle units N and, preferably, respective recirculation units R mounted adjacent the nozzle units. The transfer plates TP have supply passaging, generally designated 201, for the flow of fluid material from the manifold 159 to the nozzle units N and recirculation passaging, generally designated 203, for the recirculation of material back to the manifold in the event one or more nozzle units are not in use (see FIG. 8). The nozzle and recirculation units N, R are attached to respective transfer plates TP by suitable means, such as threaded fasteners indicated at 209 in FIGS. 5-7. Preferably, each transfer plate TP is constituted by a single monolithic body of metal or other suitable material. Alternatively, the plate can comprise separate pieces.

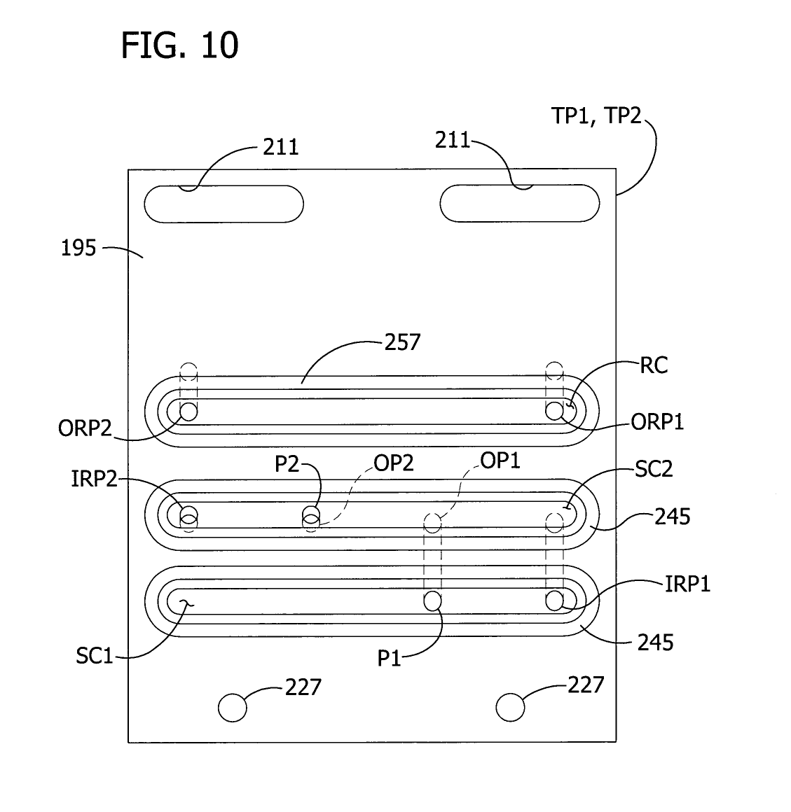

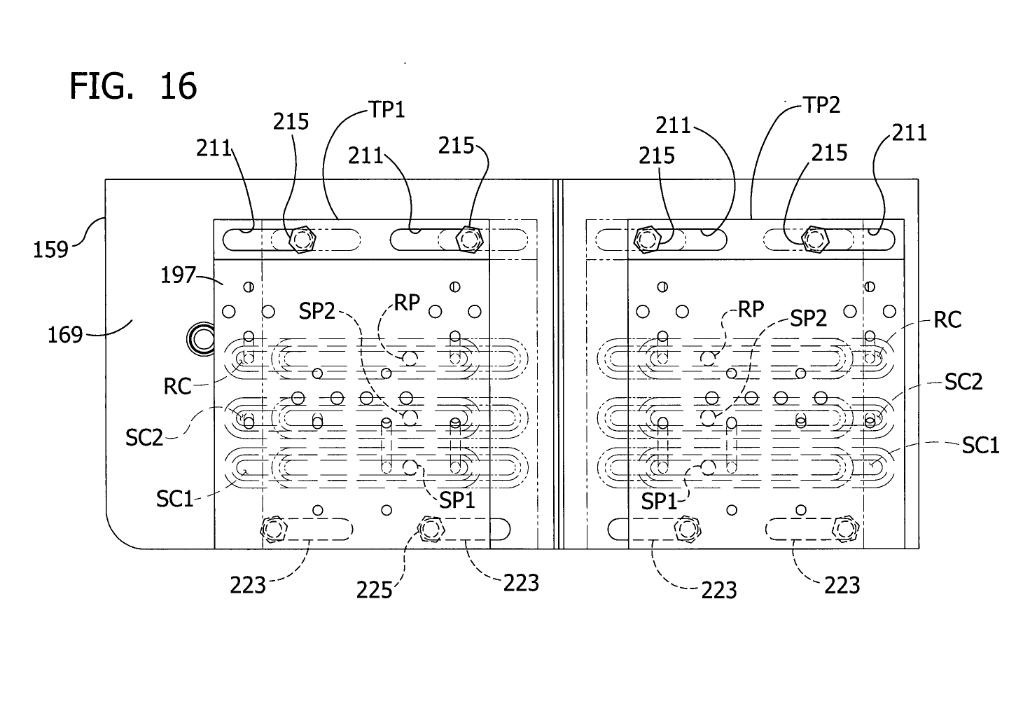

FIGS. 6 and 16 illustrate a mounting system for mounting each transfer plate TP on the manifold and allowing adjustment of the position of the transfer plate and nozzle units N thereon relative to the manifold 159 in the cross-machine direction. In one embodiment, the mounting system includes a plurality of upper slots 211 in the upper part of the plate TP (e.g., two slots 211 in each of the two front transfer plates TP1, TP2 and four slots 211 in the rear transfer plate TP3) extending in the cross-machine direction CD, and threaded fasteners 215 in the upper slots 211 threaded into the manifold 159. For further stability, the manifold has mounting flanges 221 (FIG. 6) along its lower front and rear edges with lower slots 223 for receiving fasteners 225 threaded into tapped holes 227 (FIG. 10) of the transfer plates TP. These lower slots 223 also extend in the cross-machine direction. By loosening the upper and lower fasteners 215, 225, the position of a transfer plate TP may be adjusted in the cross-machine direction CD to accommodate product dimension changes. After adjustment, the fasteners 215, 225 may be tightened to secure the transfer plates in adjusted position. Other mounting systems may be used which allow for such adjustment.

The flow of material to each nozzle unit N and to its associated recirculation unit R is controlled by a control system 229 comprising, in one embodiment (FIG. 8), a first valve 231 in each nozzle unit N movable between an open position permitting flow of material through the nozzle 115 of the nozzle unit and a closed position blocking such flow, and a second valve 235 in an associated recirculation unit R movable between an open position permitting flow through the recirculation unit and a closed position blocking flow. As will be described in greater detail later, the control system 229 operates to control these valves 231, 235 to selectively direct material either to the nozzle unit N for dispensing on the substrate 105 or to the associated recirculation unit R for recirculation in the event the nozzle unit is not in use.

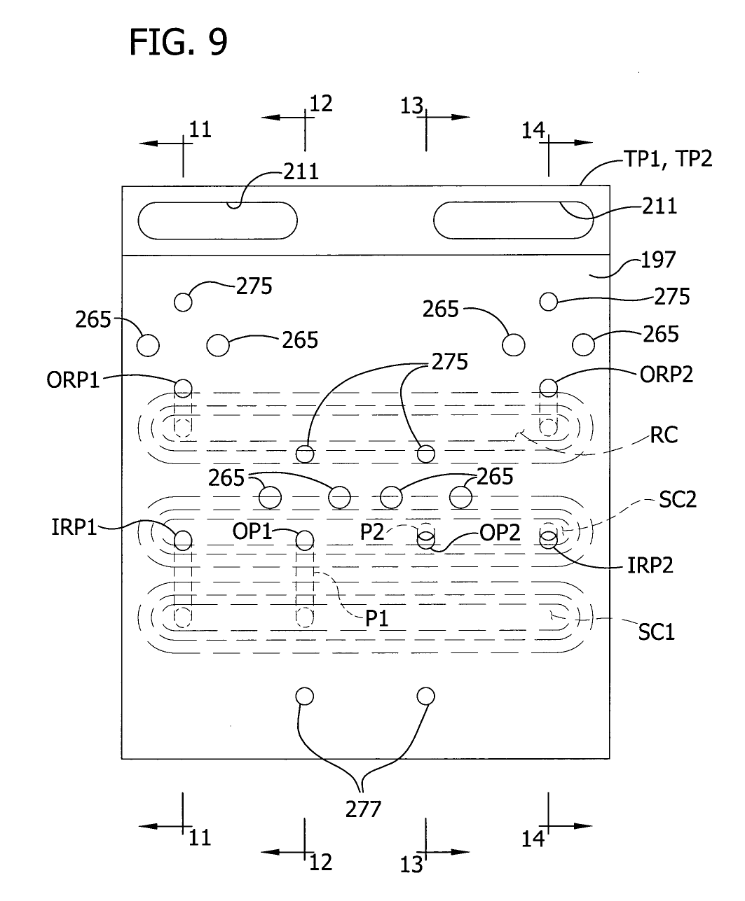

A path of fluid flow from the manifold 159 to one of the two front banks 105L, 105R of nozzle units N will now be described. (The path is identical for both front banks.) In the particular embodiment of FIGS. 9, 10, 12 and 13, fluid material to the two nozzle units N1, N2 of each front nozzle bank is delivered through respective first and second supply ports SP1, SP2 in the front face 169 of the manifold 159, one supply port (e.g., SP2) being disposed above the other (e.g., SP1). The two supply ports SP1, SP2 are preferably vertically aligned, although they may be offset in the cross machine direction CD to some extent.

The supply passaging 201 in the transfer plate TP includes a first elongate supply channel SC1 in the first (rear as shown) face 195 of the plate in fluid communication with the first supply port SP1 in the manifold 159, and a second elongate supply channel SC2 in the rear face 195 of the transfer plate in fluid communication with the second supply port SP2 in the manifold. These two supply channels SC1, SC2 extend in cross-machine direction and are located one above the other (see FIGS. 9 and 10), preferably at the same spacing as the spacing between the first and second supply ports SP1, SP2, although this is not critical so long as fluid communication is maintained between the supply channels and respective supply ports. Each supply channel SC is surrounded by a gasket 241 which is received in a groove 245 in the transfer plate TP and seals against the front face 169 of the manifold 159.

The supply passaging 201 in the transfer plate TP1, TP2 also includes first and second transfer plate outlet ports OP1, OP2 in the second (front) face 197 of the plate, and first and second supply passages P1, P2 in the transfer plate connecting the supply channels SC1, SC2 to respective outlet ports OP1, OP2. The nozzle units N are secured to the transfer plate TP so that their inlet ports 113 are in fluid communication with respective transfer plate outlet ports OP1, OP2. Suitable seals (not shown) are provided for sealing the interface between the transfer plate TP and the nozzle units N at the various openings OP1, OP2, 113. The arrangement is such that when the valve 231 in a nozzle unit N is open and the valve 235 in an associated recirculation unit R is closed, fluid flows from the manifold 159 to the nozzle N via a respective manifold supply port SP, transfer plate supply channel SC, transfer plate supply passage P, transfer plate outlet port OP, nozzle unit inlet port 113, and nozzle passage 119 for delivery through the nozzle orifice 117 onto the substrate 105.

The recirculation passaging 203 in the transfer plate TP1, TP2 comprises a first inflow recirculation passage IRP1 providing fluid communication between the first manifold supply port SP1 and the inlet port 125 of one recirculation unit R1, and a second inflow recirculation passage IRP2 providing fluid communication between the second manifold supply port SP2 and the inlet port 125 of the other recirculation unit R2. As shown best in FIG. 11, the first inflow recirculation passage IRP1 extends from and communicates with the first supply channel SC1 in the rear face 195 of the transfer plate TP1 and, as shown in FIG. 14, the second inflow recirculation passage IRP2 extends from and communicates with the second supply channel SC2 in the rear face 195 of the transfer plate. In effect, the first supply channel SC1 forms a fluid juncture between the first supply passage P1 leading to the first nozzle unit N1 and the first inflow recirculation passage IRP1 leading to the associated recirculation unit R1. Similarly, the second supply channel SC2 forms a fluid juncture between the second supply passage P2 leading to the second nozzle unit N2 and the second inflow recirculation passage IRP2 leading to the associated recirculation unit R2. Suitable seals (not shown) are provided to seal the interface between the first and second inflow recirculation passages IRP1, IRP2 in the transfer plate TP and the respective inlet ports 125 of the recirculation units R1, R2.

The recirculation passaging 203 further comprises a first outflow recirculation passage ORP1 providing fluid communication between the outlet port 127 of the recirculation unit R1 associated with the first nozzle unit N1 and the manifold return port RP, and a second outflow recirculation passage ORP2 providing fluid communication between the outlet port 127 of the recirculation unit R2 associated with the second nozzle unit N2 and the manifold return port RP. Suitable seals (not shown) are provided to seal the interface between the first and second outflow recirculation passages ORP1, ORP2 in the transfer plate TP and the respective outlet ports 127 of the recirculation units R1, R2. The first and second outflow recirculation passages ORP1, ORP2 comprise a common return channel RC in the first (rear) face 197 of the transfer plate TP in fluid communication with the manifold return port RP. The return channel RC also extends in the cross-machine direction, being generally parallel to the first and second supply channels SC1, SC2. The return channel RC is surrounded by a gasket 255 which is received in a groove 257 in the transfer plate TP1, TP2 and seals against the front face 169 of the manifold 159. In one advantageous embodiment (FIGS. 6 and 16), the manifold return port RP is vertically aligned with the first and second supply ports SP1, SP2 and the three channels SC1, SC2, RC have substantially the same lengths and are disposed in stacked relation, meaning that at least a portion of each of the three channels overlaps a portion of each of the other two channels.

Thus, if the control valve 231 associated with the first nozzle unit N1 is closed, and the control valve 235 of the associated recirculation unit R1 is open, fluid exiting the first supply port SP1 in the manifold 159 will recirculate back to the manifold via the first supply channel SC1, the first inflow recirculation passage IRP1, through the respective recirculation unit R1, the first outflow recirculation passage ORP1, the return channel RC, and into the manifold return port RP. Similarly, if the control valve 231 associated with the second nozzle unit N2 is closed and the control valve 235 of the associated recirculation unit R2 is open, fluid exiting the second supply port SP2 in the manifold 159 will recirculate back to the manifold via the second supply channel SC2, the second inflow recirculation passage IRP2, through the respective recirculation unit R2, the second outflow recirculation passage ORP2, the return channel RC, and into the manifold return port RP.

Referring to FIGS. 6 and 7, the rear bank 107 of nozzle units N3-N6 and associated transfer plate TP3 and recirculation units R3-R6 are constructed in substantially the same manner as the front banks 105L, 105R, except that there are two separate stacks of supply channels SC (two channels SC per stack) in the rear transfer plate TP3 disposed in stacked relation to a common return channel RC which returns recirculated material from all four recirculation units R3-R6 to a single return port RP on the rear face 171 of the manifold 159. As viewed in FIG. 7, the left pair of supply channels SC correspond in function and design to the first and second supply channels SC1, SC2 of the left front bank 105L of nozzle units N1, N2 and distributes fluid to and from the left two nozzle units N3, N4 of the rear bank 107 of nozzle units and their associated recirculation units R3, R4. The right pair of supply channels SC corresponds in function and design to the first and second supply channels SC1, SC2 of the right front bank 105R of nozzle units N1, N2 and distributes fluid to and from the right two nozzle units N5, N6 of the rear bank of nozzle units and their associated recirculation units R5, R6.

The return channel RC collects recirculated material from all four recirculation units R3-R6 and returns it to the return port RP in the rear face 171 of the manifold 159. All of the channels SC, RC are surrounded by sealing gaskets 271 (FIG. 7) of the type previously described with respect to the front transfer plates TP1, TP2. In the particular embodiment shown, the return channel RC extends in the cross-machine direction CD substantially the full width of the rear transfer plate TP3. Each of the two pairs of supply channels SC extends in the cross-machine direction less than one-half the overall width of the transfer plate TP3, but each such channel is longer than the overall width of a nozzle unit N. Other configurations are possible. For example, all four supply channels SC supplying material to respective nozzle units N3-N6 could be arranged in a single stack, with each channel having a length the same as that of the recirculation channel RC.

Pressurized air is delivered to the applicator 101 from a suitable source through air passaging 275 in the various transfer plates TP and nozzle units N to operate the valves 231, 235 of the control system 229 for controlling the flow of material to selected nozzle units N and, if one or more nozzle units are not in use, to the recirculation unit R associated with each such nozzle unit. In one embodiment, these valves are spring-biased toward a normally closed position, and the control system is operable to move the first and second valves 231, 235 of each nozzle unit N and associated recirculation unit R between a material deposit condition in which the first valve 231 is open and the second valve 235 is closed so that material is directed through the nozzle orifice onto the substrate, and a material recirculating condition in which the first valve 231 is closed and the second valve 235 is open to divert the flow of material to the recirculation unit, as described above. Preferably (but not necessarily), the control system 229 is operable to move the two valves 231, 235 substantially simultaneously between their respective positions. While the valves 231, 235 are illustrated in the drawings as being located in the nozzle and recirculation units N, R per se, the valves could be located anywhere downstream of the respective manifold supply ports.

Pressurized air may also be delivered from another suitable source through air passaging 277 in the transfer plates TP and nozzle units N. (For convenience, much of this passaging is omitted from the drawings.) As will be understood by those skilled in the art, this air is used to entrain the material (e.g., hot-melt adhesive) flowing through respective nozzle orifices 117 and to impart a desired distribution and motion, such as a spray, a swirling motion, etc. to the material as it moves toward the substrate 105. Reference may be made to the aforementioned U.S. Pat. Nos. 4,949,668, 4,995,333 and 5,618,347 for further detail regarding this air flow.

Material flowing through the applicator 101 is heated by suitable heaters, including a plurality of heaters 281 (FIG. 5) for heating the manifold 159, and one or more heaters 283 for heating each transfer plate and associated nozzle and recirculation units N, R. Thermocouple units 287 are suitably placed throughout the applicator for controlling the operation of the heaters 281, 283. The heating system is conventional and will not be described in detail.

In view of the foregoing, it will be observed that an applicator of the present invention enjoys advantages over prior designs. For example, the stacked configuration of the supply and return channels SC, RC in at least one (and preferably all) transfer plate TP advantageously allows for a greater range of adjustment of the nozzle units N in the cross-machine direction, since the parallel channels can be longer than the channels in the conventional design of FIGS. 3 and 4 where the channels 29 are linearly aligned in the cross-machine direction. For example, the front transfer plates TP1, TP2 (and hence the nozzle units N) thereon are each positionable up to substantially the full width (e.g., about 0.875 inches) of one nozzle unit N.

It will be understood that the lengths of the channels SC, RC may vary, depending on the desired range of adjustment in the cross-machine direction, so long as the channels remain in fluid communication with respective manifold supply and return ports SP, RP throughout the entire range of adjustment in the cross-machine direction. Further, the lengths of the channels SC, RC may vary relative to one another. Also, the number of stacked supply channels SC for a particular nozzle bank 105L, 105R, 107 will vary depending on the number of nozzle units N in the bank. For example, this number could be three, four or more to accommodate three, four or more nozzle units in the nozzle bank.

It will be noted that the recirculation configurations described above require only one manifold return port RP per bank of nozzle units N. As a result, the amount of passaging in the manifold 159 is substantially reduced, which reduces the size and cost requirements of the manifold. For example, a prior applicator 1 as shown in FIG. 1 with eight nozzle units has a height of 9.4 in. and a width (machine direction) of 13.1 in., thereby defining a cross-sectional area in the machine direction of about 117 in². A corresponding applicator 101 of the present invention has an exemplary height of about 5.0 in. and a width of about 10.4 in., thereby defining a cross-sectional area in the machine direction of about 52 in², representing a substantial reduction (e.g., more than about 50 percent) in size which can be a significant improvement in a space constrained production line.

Further, the recirculation configuration of the present invention reduces the amount of dead space in which fluid material can stagnate when one or more recirculation valves 235 are closed, as during downtime of the applicator 101, or when one or more nozzle units N are not in use because they are not needed for making a particular dimension of product. In this regard, it will be noted that most of the recirculation passaging 203 comprises relatively short inflow and outflow passages IRP1, ORP1 inside the transfer plates TP. Because of the reduced volume of stagnant material, and because of the possibly reduced heating temperatures in the transfer plates compared to the manifold, the amount of material tending to char due to prolonged heating is reduced. Further, while char formation is still possible, it is less problematic because char carried by the return line 185 in the manifold 159 can be filtered before it is recirculated back to the nozzle units N.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. Apparatus for depositing a pattern of fluid material onto a substrate moving in a machine direction, said apparatus comprising:
at least first and second nozzle units substantially aligned in a direction of alignment;
a delivery system for delivering said material to said nozzle units, said delivery system comprising
a manifold having first and second supply ports located one above the other for supply of material to the nozzle units, and
a transfer plate disposed between the manifold and the nozzle units, said nozzle units being secured to said transfer plate,
supply passaging in the transfer plate for the delivery of material from the manifold supply ports to said nozzle units, said supply passaging comprising a first elongate supply channel in a first face of the transfer plate in fluid communication with said first supply port in the manifold, and a second elongate supply channel in said first face of the transfer plate in fluid communication with said second supply port in the manifold, said first and second supply channels extending in said direction of alignment and being located one above the other in stacked relation; and
a mounting system for mounting said transfer plate on the manifold, said mounting system allowing adjustment of the position of the transfer plate and nozzle units thereon relative to the manifold in said direction of alignment, said manifold supply ports remaining in fluid communication with respective supply channels during said adjustment.

2. Apparatus as set forth in claim 1 wherein said first and second nozzle units have inlet ports for receiving said material and nozzles for depositing said material on said substrate, and wherein said transfer plate has first and second outlet ports in fluid communication with respective inlet ports, and first and second passages in the transfer plate connecting the first and second supply channels to respective transfer plate outlet ports, said transfer plate outlet ports being located in a second face of said transfer plate opposite said first face.

3. Apparatus as set forth in claim 1 wherein each nozzle unit has an overall width extending in said direction of alignment, and wherein each supply channel has a length greater than said overall width.

4. Apparatus as set forth in claim 3 wherein said supply channels are of substantially the same length and stacked directly above one another.

5. Apparatus as set forth in claim 1 wherein said mounting system comprises at least one elongate slot in one of the transfer plate and the manifold, said slot extending in said direction of alignment, and a fastener extending through the slot for fastening the transfer plate to the manifold.

6. Apparatus as set forth in claim 1 further comprising
a first recirculation unit mounted on said transfer plate, said first recirculation unit having an inlet port for receiving said material and an outlet port,
a second recirculation unit mounted on said transfer plate, said second recirculation unit having an inlet port for receiving said material and an outlet port,
a control system for selectively directing said material either to a nozzle unit for deposit of the material on said substrate or to a respective recirculation unit for recirculation back to said manifold, and
a return port in the manifold for receiving material from the first and second recirculation units.

7. Apparatus as set forth in claim 6 further comprising:
first recirculation passaging in the transfer plate comprising a first inflow recirculation passage providing fluid communication between said first manifold supply port and the inlet port of the first recirculation unit, and a first outflow recirculation passage providing fluid communication between the outlet port of the first recirculation unit and the return port of the manifold, and
second recirculation passaging in the transfer plate comprising a second inflow recirculation passage providing fluid communication between said second manifold supply port and the inlet port of the second recirculation unit, and a second outflow recirculation passage providing fluid communication between the outlet port of the second recirculation unit and the return port of the manifold,
said first and second outflow recirculation passages comprising a common return channel in said first face of the transfer plate in fluid communication with said manifold return port, said return channel extending in said direction of alignment and being spaced from said first and second supply channels so that all three channels are in stacked relation to one another.

8. Apparatus as set forth in claim 1 further comprising:
a first recirculation unit mounted on said transfer plate, said first recirculation unit having an inlet port for receiving said material and an outlet port,
a control system for selectively directing said material either to said first nozzle unit for deposit of the material on said substrate or to said first recirculation unit for recirculation back to said manifold,
a return port in the manifold for receiving material from the first recirculation unit, and
first recirculation passaging in the transfer plate comprising a first inflow recirculation passage providing fluid communication between said first manifold supply port and the inlet port of the first recirculation unit, and a first outflow recirculation passage providing fluid communication between the outlet port of the first recirculation unit and the return port of the manifold,
said first outflow recirculation passage comprising a return channel in said first face of the transfer plate in fluid communication with said manifold return port, said return channel extending in said direction of alignment and being spaced from said first and second supply channels so that all three channels are in stacked relation to one another.

9. Apparatus as set forth in claim 1 wherein said first and second transfer plate outlet ports are in a second face of the transfer plate opposite said first face.

10. Apparatus as set forth in claim 1 wherein said first and second nozzle units comprise a first bank of nozzle units for depositing material along a first side margin of said substrate, and wherein said apparatus further comprises a second bank of nozzle units mounted on a second transfer plate for depositing material along a second side margin of said substrate, said first and second banks of nozzles being adjustable in said direction of alignment toward and away from one another.

11. Apparatus as set forth in claim 1 wherein said direction of alignment comprises a cross-machine direction extending generally transverse to the machine direction.

12. Apparatus as set forth in claim 1 wherein each nozzle unit has a width, the position of the transfer plate and nozzle units thereon relative to the manifold in said direction of alignment being adjustable within a range of up to at least about the width of said nozzle unit.

13. Apparatus for depositing a pattern of fluid material onto a substrate moving in a machine direction, comprising:
a nozzle unit having an inlet port for receiving said material and a nozzle for depositing said material on said substrate,
a recirculation unit having an inlet port for receiving said material and an outlet port,
a delivery system for delivering said material to said nozzle unit, said delivery system comprising
a control system for selectively directing said material either to the nozzle unit for dispensing on said substrate or to the recirculation unit for recirculation,
a manifold having a supply port for supply of material to the inlet port of the nozzle unit, and a return port for receiving material from the recirculation unit,
a transfer plate having a first face facing said manifold,
first supply passaging in the transfer plate providing fluid communication between said manifold supply port and the inlet port of the nozzle unit, said supply passaging comprising an elongate channel in said first face of the transfer plate,
first recirculation passaging in the transfer plate comprising a first inflow recirculation passage providing fluid communication between said manifold supply port and the inlet port of said recirculation unit, and a first outflow recirculation passage providing fluid communication between the outlet port of the recirculation unit and the return port of the manifold, said outflow recirculation passage comprising an elongate return channel in said first face of the transfer plate in a generally stacked relation with said supply channel,
the nozzle unit and recirculation unit being attached to the transfer plate with the inlet port of the nozzle unit in fluid communication with said supply passaging in the transfer plate, with the inlet port of the recirculation unit in fluid communication with said inflow recirculation passage in the transfer plate, and with the outlet port of said recirculation unit in fluid communication with said outflow recirculation passage in the transfer plate, and
the transfer plate being mounted on said manifold with said supply channel in the transfer plate in fluid communication with said manifold supply port and with said return channel in the transfer plate in fluid communication with said manifold return port.

14. Apparatus as set forth in claim 13 wherein said supply and return channels are stacked directly one above the other.

15. Apparatus as set forth in claim 13 wherein the elongate channel and the elongate return channel in said first face of the transfer plate each extend in a cross-machine direction generally transverse to the machine direction.

16. Apparatus for depositing a pattern of fluid material onto a substrate moving in a machine direction, comprising:
at least a first nozzle unit having an inlet port for receiving said material and a nozzle for depositing said material on said substrate;
at least a first recirculation unit having an inlet port for receiving said material and an outlet port;
a delivery system comprising:
a control system for selectively directing said material either to the nozzle unit for dispensing on said substrate or to the recirculation unit for recirculation;
a manifold having a first supply port for supply of material to the inlet port of the nozzle unit, and a return port for receiving material from the recirculation unit;
a transfer plate secured to said manifold, said transfer plate having a first face facing said manifold;
first supply passaging in the transfer plate providing fluid communication between said manifold supply port and the inlet port of the nozzle unit; and first recirculation passaging in the transfer plate comprising a first inflow recirculation passage providing fluid communication between said manifold supply port and the inlet port of said recirculation unit, and a first outflow recirculation passage providing fluid communication between the outlet port of the recirculation unit and the return port of the manifold;
the nozzle unit and recirculation unit being attached to the transfer plate with the inlet port of the nozzle unit in fluid communication with said supply passaging in the transfer plate, with the inlet port of the recirculation unit in fluid communication with said inflow recirculation passage in the transfer plate, and with the outlet port of said recirculation unit in fluid communication with said outflow recirculation passage in the transfer plate.

17. Apparatus as set forth in claim 16 wherein said fluid supply passaging communicates with said inflow recirculation passage at a fluid juncture, and wherein said control system comprises a first valve downstream of said fluid juncture movable between an open position permitting flow of material through the nozzle of the nozzle unit and a closed position blocking said flow, and a second valve downstream of said fluid juncture movable between an open position permitting flow through the recirculation unit and a closed position blocking said flow.

18. Apparatus as set forth in claim 17 wherein said control system is operable to move the first and second valves between a material deposit condition in which the first valve is open and the second valve is closed and a material recirculating condition in which the first valve is closed and the second valve is open, and wherein said control system is operable to move the two valves substantially simultaneously between their respective positions.

19. Apparatus as set forth in claim 17 wherein said first valve is in said nozzle unit and said second valve is in said recirculation unit.

20. Apparatus as set forth in claim 16 further comprising:
a second nozzle unit having an inlet port for receiving said material and a nozzle for depositing said material on said substrate;
a second recirculation unit having an inlet port for receiving said material and an outlet port;
a second supply port on the manifold for supply of material to the inlet port of the second nozzle unit;
second supply passaging in the transfer plate providing fluid communication between said second manifold supply port and the inlet port of the second nozzle unit, and;
second recirculation passaging in the transfer plate comprising a second inflow recirculation passage providing fluid communication between said second manifold supply port and the inlet port of the second recirculation unit, and a second outflow recirculation passage providing fluid communication between the outlet port of the second recirculation unit and the return port of the manifold.

21. Apparatus as set forth in claim 20 wherein said first and second outflow recirculation passages comprise a common channel in fluid communication with said manifold return port.

22. Apparatus as set forth in claim 16 wherein said first and second manifold supply ports are located one above the other, and wherein said first and second supply passaging comprise supply channels in said first face of the transfer plate located one above the other in stacked relation and in fluid communication with respective manifold supply ports, said supply channels extending in said cross-machine direction.

23. Apparatus as set forth in claim 16 wherein said first nozzle unit and said first recirculation unit are attached to a second face of the transfer plate opposite said first face.
